(19) United States
(12) Patent Application Publication
(10) Pub. No.: US 2011/0058905 A1
(43) Pub. Date: Mar. 10, 2011

(54) DEVICE FOR DISCHARGING A SOLID MATERIAL FROM A CONTAINER

(75) Inventors: Stefan Hamel, Wenden (DE); Eberhard Kuske, Soest (DE)

(73) Assignee: UHDE GmbH, Dortmund (DE)

(21) Appl. No.: 12/736,868

(22) PCT Filed: May 8, 2009
(86) PCT No.: PCT/EP2009/003282

§ 371 Date: Nov. 18, 2010

(30) Foreign Application Priority Data
May 21, 2008 (DE) 102008024576.3

(51) Int. Cl. B65G 53/38; B05B 7/00; B65G 69/06

(52) U.S. Cl. 406/138; 222/630; 222/195; 222/460

(57) ABSTRACT

With a device for discharge, particularly of a very fine-grained solid material or solid material mixture, from a container having a discharge funnel in the direction of gravity, underneath the main container part, a solution is to be created, with which the disadvantages of double-wall cone designs, particularly also at high system pressures, are avoided, with a simple, versatile design. This is achieved in that a part (3) of the discharge funnel in the upper region that faces the container (2) is formed partly by the container wall itself, which makes a transition into a cylindrical lower container part (4), while the further part that carries the discharge adapter (14) is formed by a separate cylinder element (9) with funnel part (11), which element is installed in the cylindrical lower container part (4).

In the thermal conversion of solid fuels, such as, for example, various types of coal, peat, hydrogenation residues, scrap materials, waste materials, biomasses, and flue ash, or a mixture of the aforementioned substances, under elevated pressure, there is the need to bring the substances being used, which are stored under normal pressure and ambient conditions, to the pressure level of thermal conversion, in order to allow conveyance into the pressurized reactor. Possible thermal methods can be, for example, pressurized combustion or pressurized gasification, according to the fluidized bed method or entrained flow method.

For this purpose, conveyance and intermediate storage of finely ground fuels are necessary. In order to bring the fuel to the pressure level of the reactor, lock systems are usually used, in which the fuel is brought to pressure in containers that are in a circuit, one behind the other. In this connection, a decisive criterion for operational safety is reliable emptying of the containers after they have been brought to high system pressures. In order to discharge micro-grained and fine-grained solid materials from a container, various approaches are fundamentally possible:

In large silos that stand under atmospheric pressure, the solid material is frequently drawn off with mechanical devices, such as, for example, clearing arms.

Fundamentally, the solid material bed can be transformed into a fluidized bed state by means of gas feed counter to gravity. The fluidized bed then acts similar to a fluid and can run out by way of discharge openings, lateral connector pieces, etc. It is disadvantageous that large amounts of gas are required. This problem is compounded by the fact that it is very difficult to transform fine particles into a homogeneous fluidized bed.

Another possibility for allowing solid material discharge from a container consists in providing conical discharge geometries, taking the bulk material properties into consideration. The solid material discharge from a cone can be supported by means of adding gas by way of or at the cone walls. In general, the amount of gas is smaller than the amount that would be required for fluidization, but sufficient to cancel out the wall friction of the bulk material and/or to prevent local trends toward bridge formation.

The latter method is the preferred variant in the gasification systems that have been described, in which fine-grained fuel must be handled both under atmospheric pressure and under high pressures. In this connection, the required amount of gas is limited, and, at the same time, it is possible to do without mechanical installations.

It is the state of the art to pass gas into the discharge cone by way of porous elements. The porous elements preferably consist of sintered metal, but can also consist of other porous media.

Some references that have funnels or cones in the discharge area should be mentioned with regard to the state of the art, for example DE 41 08 048, EP 3 480 008 B1, FR 1 019 215 A, WO 2004/085578 A1, U.S. Pat. No. 5,106,240, WO 89/11378, or U.S. Pat. No. 4,941,779.

All the cones by way of which a gas is passed into a solid bulk material generally have in common that a double-wall design is used, whereby the outer wall represents the delimitation toward the surroundings and the inner wall, which is gas-permeable in one of the forms described, guides the solid material to the discharge opening. The components, which are mostly configured using welding technology, are subjected to corresponding production tolerances, which can lead to the result that installation is carried out with small deviations from the optimal position, and this can already lead to disadvantageous stresses. Furthermore, in practice, different temperatures of the gas being fed in and of the solid material to be discharged generally occur. As a result, stresses occur in the component. These stresses, also together with the production tolerances, can lead to small deviations that are expressed in increased leakage rates and/or in a reduced useful lifetime.

The invention proceeds from EP 1 551 736 or US 2006/0013660, respectively. In this connection, it is the goal of the invention to overcome the disadvantages of the known double-wall cone design that have been described, and furthermore to make available a more cost-advantageous solution for a broad area of use, particularly also for high system pressures, but also for higher temperatures and temperature gradients.

This task is accomplished, according to the invention, with a device of the type indicated initially, in that a part of the discharge funnel in the upper region that faces the container is formed partly by the container wall itself, which makes a transition into a cylindrical lower container part, while the further funnel part that carries the discharge connector piece is formed by a separate cylinder element having a funnel part, which element is installed in the lower cylindrical container part.

A number of advantages is achieved with the invention; in particular, no consideration has to be taken of special tolerances during welding work, because of the installability. Seals are provided on cylindrical elements to the extent that this is necessary, as is described in greater detail below, etc.

Embodiments of the invention are evident from the dependent claims. In this connection, it can particularly be provided that the lower container part and the cylinder element with funnel part can be connected with one another by means of flanges, whereby the flange connections as such are already used in the reference that forms the type, although there they are used for conical elements.

It is advantageous if the cylindrical lower container part that carries the flange and the cylinder element of the funnel part that carries the flange have a slight distance from one another in the installed position, as the invention also provides.

A particularly practical embodiment of the invention consists in that the funnel part is configured in two pieces in the discharge region, with a cylindrical end region that is provided with a tubular, cylindrical discharge adapter. In this way, the device can be adapted to an abundance of purposes of use and cases of use, in such a manner that a type of modular construction is made possible.

It is practical in this embodiment if the discharge adapter in turn is provided with an outer flange that can be connected with the flange disk of the funnel part.

Another embodiment of the invention consists in that essential parts of the funnel part are formed by a gas-permeable, porous wall, as is actually known, whereby a gas feed ring space is formed between cylinder element and the gas-permeable funnel wall.

As was already mentioned above, the cylindrical lower container part and the cylindrical wall of the funnel part have a slight distance from one another; here, it can be provided, according to the invention, in another embodiment, that an apron that bridges the gap between the cylindrical walls is provided in the transition region of the funnel wall of the container and of the discharge funnel.

Other details, characteristics, and advantages of the invention are evident from the following description and using the drawing. This shows:

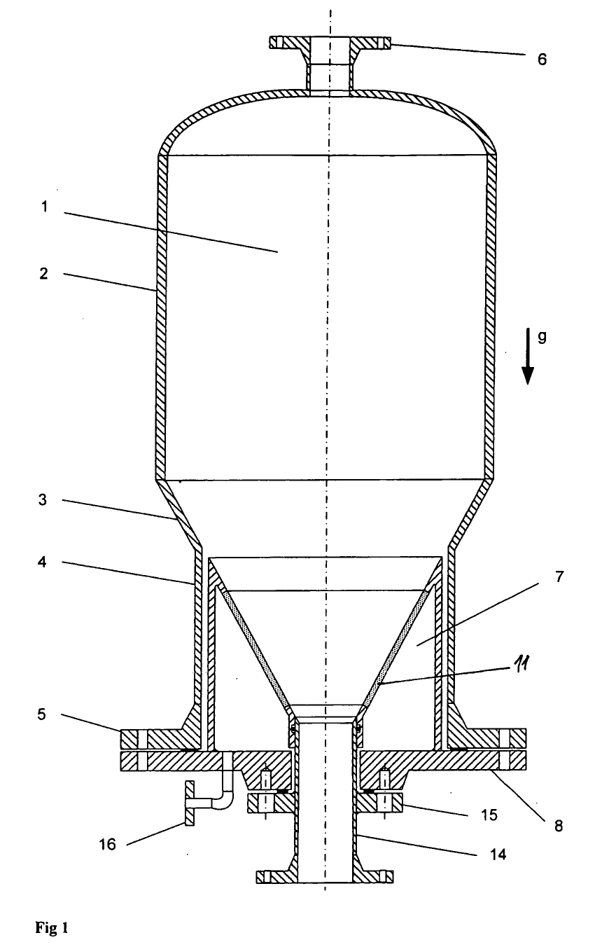

FIG. 1 the schematic sectional representation of a device according to the invention, and in

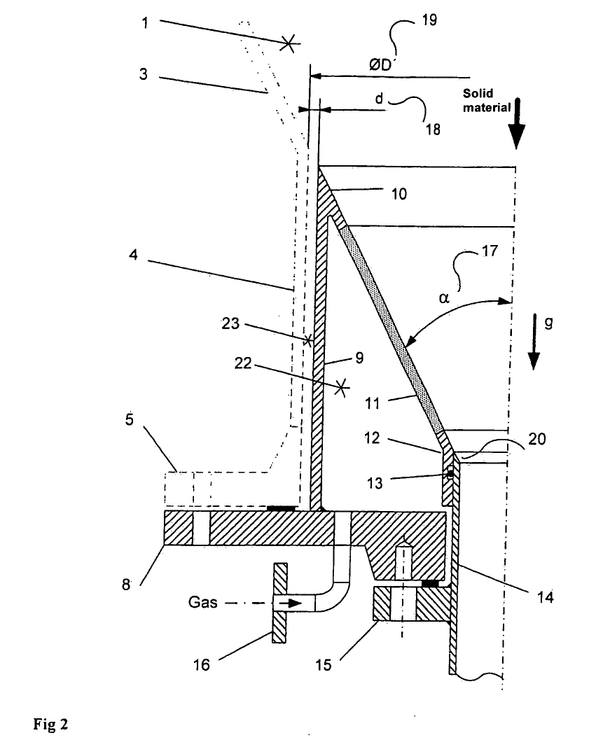

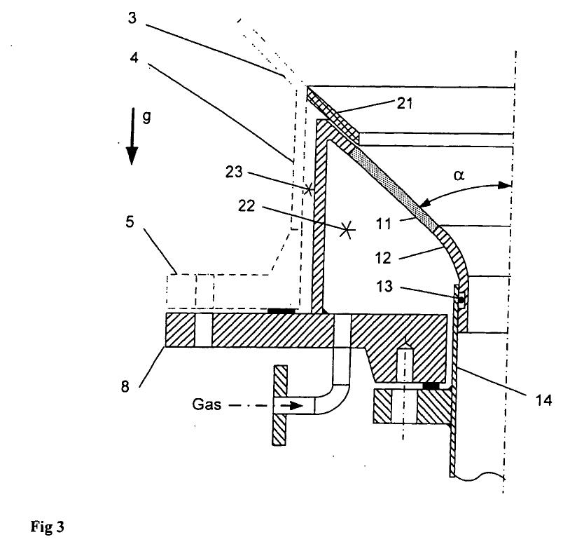

FIGS. 2 and 3 detail partial sections of the exit funnel in an enlarged but overall schematic representation.

The invention relates to the a device for discharge of solid material from a container that serves for conveying and/or storing fine-grained material such as ground coal or flue dust, for example.

The container 1 shown in FIG. 1 consists of a main part 2, which is equipped with corresponding feed openings 6 for filling it with solid material, and with other connector pieces, not shown here, for gas feed and discharge and measurement connector pieces, etc. The representation is not true to scale; in particular, the main part is shown in greatly reduced size. In this connection, the main part can have a rectangular cross-section, and can also be shaped cylindrically. In the lower part of the container, a converging piece container cone 3 follows (conical in rectangular or cylindrical shape), at the lower end of which a cylindrical lower container part 4 having a connector flange 5 is situated. This cylindrical lower part 4 serves to accommodate the actual discharge device 7, which is attached to the flange 5 of the lower container part 4 by way of the device flange 8.

The discharge device 7, see also FIGS. 2 and 3, consists of a counter-flange 8 to which a cylindrical wall 9 is attached, at the upper end of which a connector piece 10 is situated, which allows the transition from the cylindrical wall 9 to the funnel part 11. The funnel part 11 consists at least in part of a gas-permeable design that can be made from sintered metal, for example, according to the state of the art, or can be provided with specially configured openings, according to a more recent application.

A connection element 12 follows the converging, partially gas-permeable wall, which element creates the geometrical transition from the converging wall to the cylindrical discharge adapter 14, for one thing, and for another, is provided with a seal 13, preferably an O-ring seal, which forms a seal between connection element 12 and the discharge adapter 14. The connection element 12 itself can be shaped in such a manner that the transition from the converging part to the cylindrical part takes place directly (see FIG. 2), or the transition from converging to cylindrical can be described with a radius, in order to obtain a “flowing” geometrical transition (FIG. 3).

In this connection, the discharge adapter 14 can be provided both within (FIG. 2) and outside of (FIG. 3) the connection element 12. If the discharge adapter 14 is guided on the inside, it is recommended to provide a chamfer 20 at the upper end, which encloses the same angle relative to the vertical as the converging part, in order to allow the smoothest possible transition into the discharge adapter for the solid material.

The discharge adapter 14 itself, in turn, is attached to the device flange 8 with a flange 15. In this connection, the bores in the flange 15 should be provided with a greater diameter than would be needed for the screw connection with 8. In this way, production and installation tolerances in the horizontal direction can be balanced out when the discharge adapter 14 is attached.

Tolerances or temperature-related expansions in the vertical direction can be compensated by means of sealing the connection element 12 relative to the discharge adapter 14 by means of a movable seal, for example an O-ring seal, while simultaneously sealing the gas space 22 relative to the interior that carries the solid material.

The entire discharge device 7 is situated concentrically within the cylindrical lower container part 4, and is connected by means of flange 8 and 5, and sealed from the surroundings. The width d 18 of the resulting ring-shaped gap 23 between the cylindrical lower container part 4 and the cylindrical wall 9 of the discharge device should be smaller than 5% of the inside diameter D 19 of the cylindrical lower container part 4.

In order to improve the flow of solid material from the converging part of the container 3 to the discharge device and in order to simultaneously cover the gap 23, attachment of a converging apron 21 can be advantageous, see FIG. 3.

The following advantages result from the proposed design:
Reduction of the production technology effort, since only a converging wall is required as the funnel part (11), in contrast to proposals that also provide for an outer converging wall. Converging elements are more complicated in production, with simultaneously clearly greater production tolerances, than cylindrical elements that are available as standard equipment.
The production technology effort is insignificantly higher, even in the case of use for high pressures, since here, the components to be designed for the operating pressure (flange 8, 15, 16, 14) are essentially standard components. In the case of proposals with a converging outer wall, this wall and the related weld connections must be designed accordingly, for high pressure. The cylindrical wall (9) that is present here, just like the sealing element (13), only has to be designed for the difference pressure that the gas needs for flowing through the permeable, converging wall, out of the gas space (22).
The design proposed here allows balancing out production technology tolerances in the horizontal direction, by means of the adjustable discharge adapter (14) with the adapter flange (15).
Because of the fact that the connection element (12), which is flexibly connected with the discharge adapter (14) by way of a seal (13), expansions that occur due to temperature gradients that are present in the component can be compensated.
The proposed design can be used for all possible angles of inclination (17) relative to the vertical, in the range of 15° to 85°. The angle of inclination is essentially determined by the bulk material properties, but also by the combination of the bulk material properties with the selected variant of the gas feed by way of the converging, gas-permeable wall. Furthermore, the diameter of the discharge adapter (14) that is selected also plays a role in the selection of the angle (17), with regard to the bulk material properties.
Gap dimension d (18) preferably less than 5% of the diameter D (19).
Transition of the converging part to the cylindrical part of the connection piece (12) can take place both with a “corner” (FIG. 2) and with a radius (FIG. 3).
The seal accommodation for the seal (13) can be provided both within (FIG. 2) the cylindrical part of the connection element (12) and outside of it (FIG. 3).
Alternatively, the accommodation of the seal (13) can also be situated in the cylindrical part of the discharge adapter (14), in place of in the cylindrical part of the connection element (12).
The gas feed (16) the amount of gas fed into the gas space (22) can be dimensioned in such a manner that the wall friction of the bulk material at the converging wall of the funnel part (11) is reduced and/or cancelled out, but at the same time, the amount of gas is less than that required for minimal fluidization of the cross-section having the diameter D (19).
For use in the case of powdered coal, the amount of gas fed in can be dimensioned in such a manner that a density of greater than 420 kg/m³ occurs in the discharge adapter during the discharge process.

### REFERENCE SYMBOL LIST

1 container
2 main container part
3 container cone
4 lower container part
5 flange
6 feed connector piece
7 discharge device
8 device flange
9 cylindrical wall
10 connector piece, cylindrical wall—converging wall
11 (funnel part) gas-permeable wall
12 connection and sealing element
13 seal
14 discharge adapter
15 adapter flange
16 gas feed
17 angle relative to the vertical
18 distance between the cylindrical wall of the discharge device and of the lower container part
19 diameter of the cylindrical lower container part
20 chamfer
21 conical apron
22 gas space
23 gap

1. Device for discharge, particularly of a very fine-grained solid material or solid material mixture, from a storage container having a discharge funnel in the direction of gravity, underneath the main container part,
wherein
a part (3) of the discharge funnel in the upper region that faces the container (2) is formed partly by the container wall itself, which makes a transition into a cylindrical lower container part (4), while the further part that carries the discharge adapter (14) is formed by a separate cylinder element (9) with funnel part (11), which element is installed in the cylindrical lower container part (4).

2. Device according to claim 1, wherein
the lower container part (4) and the cylinder element (9) with funnel part (11) can be connected with one another by means of flanges (5, 8).

3. Device according to
claim 1, wherein
the cylindrical lower container part (4) that carries the flange (5) and the cylinder element (9) with funnel part (11) that carries the flange (8) have a slight distance (18) from one another in the installation position.

4. Device according to
claim 1, wherein
the funnel part (11) is configured in two pieces in the discharge region, with a cylindrical connection element (12) that is provided with a tubular, cylindrical discharge adapter (14).

5. Device according to claim 4, wherein
the discharge adapter (14) in turn is provided with an outer flange (15) that can be connected with the flange disk (8) of the funnel part (11).

6. Device according to
claim 1, wherein
significant regions of the funnel part (11) are formed by a gas-permeable wall, as is actually known, whereby a gas feed ring space (22) is formed between cylinder element and the gas-permeable funnel wall.

7. Device according to
claim 1, wherein
an apron (21) that bridges the gap (23) between the cylindrical walls (4, 9) is provided in the transition region of the funnel wall of the container and of the discharge funnel.
